(19) United States
(12) Patent Application Publication
(10) Pub. No.: US 2013/0048859 A1
(43) Pub. Date: Feb. 28, 2013

(54) SAMPLE ANALYSIS USING TERAHERTZ SPECTROSCOPY

(71) Applicants: Maik Scheller, Tucson, AZ (US); Martin Koch, Kirchhain (DE); Christian Jansen, Braunschweig (DE); Steffen Wietzke, Lehrte (DE)

(72) Inventors: Maik Scheller, Tucson, AZ (US); Martin Koch, Kirchhain (DE); Christian Jansen, Braunschweig (DE); Steffen Wietzke, Lehrte (DE)

(21) Appl. No.: 13/582,486

(22) PCT Filed: Feb. 24, 2011
(86) PCT No.: PCT/EP2011/000904

§ 371 Date: Nov. 12, 2012

(30) Foreign Application Priority Data
Mar. 4, 2010 (DE) 1020100102857

(51) Int. Cl. G01N 21/35

(52) U.S. Cl. 250/339.08; 250/339.07

(57) ABSTRACT

The invention relates to a method for analysing the material of a sample (3) using terahertz spectroscopy in order to identity material irregularities of the sample (3), having the following steps: (a) a terahertz wave transmitting device (5, 8) is used to transmit electromagnetic waves (6, 9) at a frequency in that terahertz range to the sample (3) to be analysed, (b) a terahertz wave receiving device (1, 8) is used to receive electromagnetic waves (7, 9) in the terahertz range from the sample (3), (c) the terahertz wave receiving device (1, 8) supplies the received waves (7, 9), in the form of a time domain signal or a frequency domain signal, to an evaluation device (10), (d) if a signal supplied to the evaluation device (10) is a time domain shier, the evaluation device (10) converts the time domain signal into a frequency domain signal (11) by means of a first spectral transformation, (e) the evaluation device (10) converts the frequency domain signal (H) into an output function (Q(x)) by means of a second spectral transformation, by means of which output function anomaly values (Q) determined are assigned to corresponding optical depth values (x) of the sample, (f) the evaluation device (10) presents the output function (Q(x)) a anomaly values (Q) with respect to optical depth values (x) on a display device and/or automatically determines at least one material irregularity (12) of the sample (3) from the output function (Q(x)) according to at toast one predefined comparison criterion.

The invention relates to a method for material analysis of a sample using terahertz spectroscopy for identifying material irregularities in the sample, according to claim 1. The invention furthermore relates to a terahertz spectroscopy analysis apparatus according to claim 11.

In general terms, the invention relates to the field of material analysis and testing. In this field, a principle distinction is made between destructive and non-destructive methods. By way of example, plastics weld seams have previously been tested using destructive methods, e.g. in the form of mechanical load testing of a sample. During the mechanical testing, it is possible to determine e.g. the solidity or rigidity of sample bodies, although this leads to the destruction of the sample. Moreover, an individual analysis is not representative of the entire produced batch, and so statistical analysis is required. Another option consists of monitoring the joining process of the plastics parts, e.g. by monitoring the parameters of temperature and pressure, in order already to minimize possible delaminations or joining faults in a prophylactic fashion.

Ultrasound analysis is currently being tested as a non-destructive analysis method. However, the previous results in respect of testing plastics weld seams still appear to be unsatisfactory.

The invention is therefore based on the object of enabling material analysis of samples, in particular for testing cohesive plastics connections, in a non-destructive, reproducible and reliable fashion.

This object is achieved by the invention specified in claims 1 and 11. The dependent claims specify advantageous developments of the invention.

According to the invention, it is proposed to apply terahertz spectroscopy for analyzing the material of a sample and to use it according to the steps specified in claim 1 for identifying material irregularities in the sample. In principle, the use of electromagnetic waves in the terahertz frequency range is a relatively new field of technology because efficient terahertz generators have only been available for approximately years, e.g. initially as sources based on femtosecond titanium-sapphire lasers or later, in a more cost-efficient variant, in the form of diode lasers which are slightly detuned with respect to one another, the difference frequency of which occurring during a mixing process lying in the terahertz range. This led to the development of the field of pulsed terahertz spectroscopy. Thus, for example, the article “Analyzing sub-100-μm samples with transmission terahertz time domain spectroscopy” by Maik Scheller, Christian Jansen, Martin Koch, published in Optics Communications 282 (2009), pages 1304 to 1306, has proposed the use of terahertz spectroscopy for determining the geometric thickness, the absorption coefficient and the refractive index in the terahertz frequency range of a sample.

In contrast to this, the invention proposes the use of the terahertz spectroscopy for identifying material irregularities, with the method being much simplified and improved in its technical applicability compared to the aforementioned article. Thus, there is no need to determine the aforementioned material parameters of geometric thickness, absorption coefficient and refractive index. This enables an implementation of the present invention with a significantly reduced requirement in terms of calculation power or calculation time of a computer.

According to the invention, provision is made for the output signal of a terahertz wave reception apparatus to be converted into a frequency-domain signal by a first spectral transform, provided that the output signal is present in the time domain. This step can be dispensed with provided that the output signal is already available in the frequency domain. Finally, the frequency-domain signal is converted into an output function using a second spectral transform. Further complicated calculation procedures are not required for implementing the invention. This allows the invention to be realized with relatively low computational complexity, and so signal evaluation in real time is made possible.

As a result, there is therefore an additional spectral transform of the received signal information. It was identified that such a procedure renders it possible to reach output variables that are directly suitable for determining material irregularities in the sample. An output function of the second spectral transform is advantageously determined such that established anomaly values are associated with corresponding optical depth values in the sample. Here, the optical depth values correspond to a product of the geometric depth of the respective anomaly in the sample multiplied by the optical refractive index of the material of the sample through which the electromagnetic waves travel up to the anomaly. The optical refractive index relates to electromagnetic waves in the terahertz range. Advantageously there is no need to determine the optical refractive index in order to carry out the method according to the invention.

The anomaly values are an indicator for material irregularities. If the amplitude of the anomaly values is relatively high at a specific optical depth value, this indicates an irregularity or an interface at this point in the sample. Hence the output function is advantageously a simple evaluable function of the type y=f(x), which can be represented on an indicator unit, for example either in tabular form or in a coordinate system as a graph. This enables a simple and fast evaluation of the results by a person carrying out the materials testing. A comparatively simple automatic evaluation of the output function is likewise possible, by virtue of at least one material irregularity in the sample being established automatically using at least one predetermined comparison criterion. By way of example, this can be brought about by setting a limit value for the anomaly values. If the anomaly values exceed the limit value, an irregularity or a defect is automatically identified in the sample.

The method is therefore particularly well suited to automatic materials testing in industrial production, without destroying the objects to be analyzed. By way of example, the invention can be used to analyze interfaces and intermediate layers in cohesive plastics connections, e.g. adhesive or welded connections, and to detect defects therein. There is also the possibility of analyzing plastics components or other dielectric materials, such as e.g. paper, lacquer coatings, ceramics or else foodstuffs, in a fast and simple fashion in respect of material irregularities such as encasements of foreign materials or undesired cavitation.

The invention also enables a quick determination of the optical layer thickness of the entire sample or individual layers of the sample. The optical thickness denotes the product of geometric thickness and optical refractive index. The information in respect of the optical layer thickness is of interest, particularly in the case where the optical refractive index of the sample or of the individual layers is known.

The invention is based on the transmission of electromagnetic waves in the terahertz frequency range through the material. Irregularities in the material lead to additional echo pulses in the received signal. These are Fabry-Perot reflections, which, according to the invention, can be detected in a simple manner and can be represented in a clear fashion or evaluated automatically. Electromagnetic waves with a frequency in the terahertz range are used as testing signal, the former being transmitted to the sample to be analyzed. This can be a single testing pulse or else a pulse train.

In principle, any transform which converts a signal with a specific periodicity into a spectral signal can be used as a spectral transform. The Fourier transform, the Z-transform, the Laplace transform or the wavelet transform are mentioned as examples of suitable spectral transforms.

According to an advantageous development of the invention, the sample has at least two plastics parts, which are cohesively (e.g. welded, adhesively bonded) interconnected. The output function is evaluated in respect of at least one material irregularity which indicates a defect in the cohesive connection. This advantageously enables an automatic, non-destructive analysis of cohesively connected plastics components. Thus, for example, undesired air encasements at the joint or delaminations can be identified automatically. It is possible to set thresholds in respect of the values that are still tolerable of the anomaly values of the output function. As a result of this, an automatic discrimination between good parts and rejects is possible, e.g. within the scope of industrial production.

According to an advantageous development of the invention, the plastics parts are interconnected by a plastics welding seam or area and/or by an adhesive seam or area. The output function is evaluated in respect of at least one material irregularity which indicates a defect in the plastics welding seam or area and/or in the adhesive seam or area. By way of example, an irregular interface profile of a plastics part, an irregular material application of the adhesive or a delamination in the case of welded/adhesively bonded areas can be detected as material irregularity in this case.

According to an advantageous development of the invention, the sample has at least one dielectric substance. The output function is evaluated in respect of at least one material irregularity in the dielectric substance. Thus, in addition to plastics parts, it is for example also possible to use the method according to the invention to analyze foodstuffs in respect of encasements and the like.

According to an advantageous development of the invention, the sample has at least one coating on a substrate. The output function is evaluated in respect of at least one material irregularity which indicates a defect between the coating and the substrate. Such an analysis of the sample can advantageously be carried out using a reflection measurement, e.g. by using the reflection arrangement described below as an exemplary embodiment. By way of example, the coating can have paper, lacquer and/or ceramics or other dielectric layers, which is for example applied to a substrate made of metal.

According to an advantageous development of the invention, the output function is evaluated in respect of the optical thickness of the sample and/or at least one layer of the sample. Hence it is possible to determine the optical thickness of the entire sample and the optical thicknesses of individual layers of the sample. As a result of this, the invention can additionally be used for determining, in a simple and quick fashion, the optical layer thickness. No complicated additional calculation steps are required because the optical layer thickness information, i.e. the product of geometric thickness and optical refractive index, is likewise already contained in the output function.

According to an advantageous development of the invention, the evaluation apparatus adjusts the frequency-domain signal using a recorded reference frequency spectrum. The reference frequency spectrum was recorded within the scope of a transmission measurement without a sample in the beam path of the electromagnetic waves. Within the scope of a reflection measurement, a metallic surface is introduced instead of the sample, and the THz signal reflected from this surface is used as reference frequency spectrum. As a result of this, a computational elimination of interferences (e.g. atmospheric damping, superposed Fabry-Perot reflections of the terahertz beam-conducting optical systems) is possible during the actual material analysis. The interferences are preferably removed on the level of the frequency-domain signal, i.e. prior to the second spectral transform. The interferences are eliminated by, for example, dividing the frequency spectrum recorded from the sample, i.e. the frequency-domain signal, by the reference frequency spectrum.

Advantageously, a spectral integral transform can be applied as first and/or second spectral transform. A spectral integral transform is used to transform a time-continuous signal into a spectral signal. In particular, use can be made of the Laplace transform. Advantageously, a discrete summation transform can be applied as first and/or second spectral transform. The discrete summation transform transforms a time-discrete signal into a spectral signal. In particular, an embodiment as fast Fourier transform (FFT) is advantageous. In particular, this enables a cost-effective realization of the invention from a data processing point of view. Thus, for example, a simple and cost-effective microcontroller, optionally combined with a signal processor (direct signal processor—DSP), or a field programmable gate (field programmable array—FPGA), can be used for calculating the output function. This opens up the possibility of using the invention on a large scale and cost-effectively in quality control in industrial production.

According to an advantageous development of the invention, the utilized terahertz range comprises the range between 0.1 and 100 THz. According to an advantageous development of the invention, the utilized terahertz range comprises the range between 0.3 and 10 THz. This likewise enables a cost-effective realization of the invention, especially since terahertz wave transmission apparatuses can in the meantime be produced in a cost-effective fashion for this frequency range.

An advantageous terahertz spectroscopy analysis apparatus for analyzing the material of a sample contains at least a terahertz wave transmission apparatus, a terahertz wave reception apparatus and an evaluation apparatus. The terahertz wave transmission apparatus and the terahertz wave reception apparatus can also be embodied as a combined transmission/reception apparatus (transceiver). The evaluation apparatus can be embodied as a single, central electronic unit, which is arranged separately or which is arranged integrated into the transmission or reception apparatus. The evaluation apparatus can also be made of a plurality of instruments arranged in a distributed fashion, such as e.g. a signal conditioning circuit and an evaluation computer. In general, the term evaluation apparatus comprises all elements by means of which a received terahertz wave signal is finally converted into the output function.

The terahertz wave transmission apparatus and the terahertz wave reception apparatus are respectively aligned with respect to the sample. The alignment with respect to the sample can be realized directly or indirectly, via deflection means.

The output signals of the terahertz wave reception apparatus are advantageously fed to the evaluation apparatus. The evaluation apparatus is prepared to carry out a method of the type described above. To this end, the evaluation apparatus can be prepared to carry out the signal conversion steps specified in claim 1, for example by appropriate software programming, for example to calculate the first and/or the second spectral transform.

According to an advantageous development of the invention, the evaluation apparatus has a microcontroller, optionally in combination with a DSP, or an FPGA for carrying out the first and second spectral transform. Advantageously, a simple and cost-effective personal computer can also be used for this purpose.

In the following text, the invention will be explained in more detail on the basis of exemplary embodiments using drawings.

In detail:

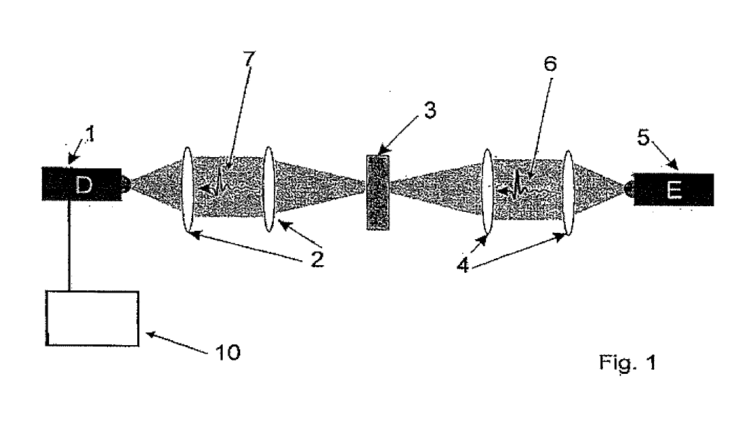

FIGS. 1 to 3 show embodiments of terahertz spectroscopy analysis apparatuses and

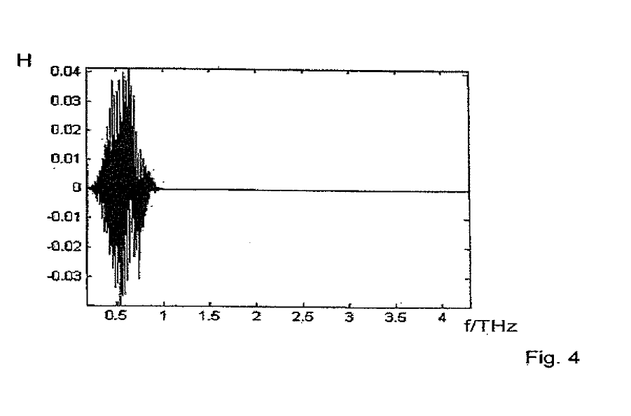

FIG. 4 shows a frequency-domain signal and

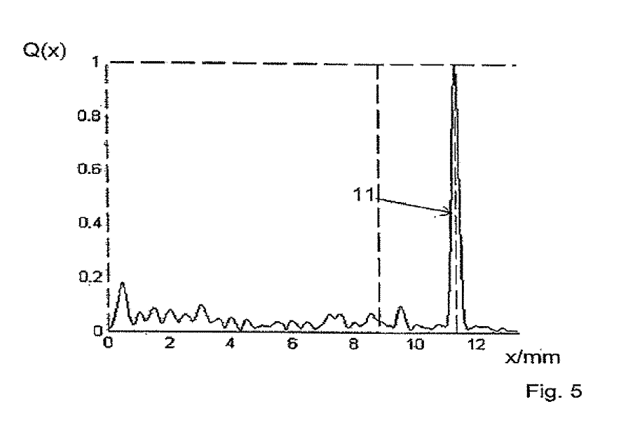

FIG. 5 shows a first output function and

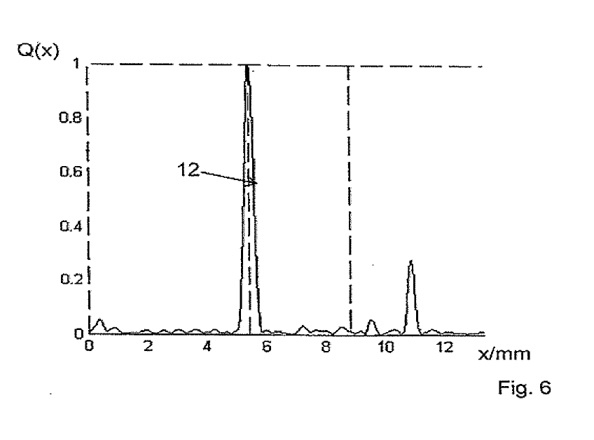

FIG. 6 shows a second output function.

The same reference signs are used in the figures for mutually corresponding elements.

FIG. 1 shows a first embodiment of a terahertz spectroscopy analysis apparatus. Provision is made for a terahertz wave transmission apparatus 5, which transmits a testing signal 6 in the time domain, in the form of electromagnetic waves with a frequency in the terahertz range onto a sample 3 to be analyzed. By way of example, the testing signal 6 can initially be collimated using lenses 4 which are effective in the terahertz frequency range and then be focused onto a specific point on the sample 3. The testing signal irradiated onto the sample 3 reemerges from the opposite side of the sample 3 while forming reflections at material irregularities and is, as time-domain signal 7, firstly collimated again via further lenses 2 and then focused onto the terahertz wave reception apparatus 1, which records the time-domain signal 7. The recorded signal is fed to an evaluation apparatus 10. The method steps according to the invention, in particular the first and the second spectral transform, are carried out within the evaluation apparatus 10.

The arrangement illustrated in FIG. 1 is also referred to as transmission arrangement because the testing signal 6 passes through the sample 3.

By way of example, the lenses 2, 4 can be made of plastics material, e.g. polyethylene.

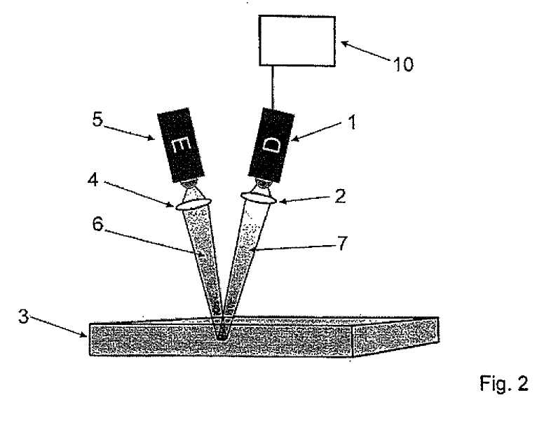

FIG. 2 shows a second embodiment of a terahertz spectroscopy analysis apparatus, in which the terahertz wave transmission apparatus 5 and the terahertz wave reception apparatus 1 are arranged on the same side of the sample 3. This arrangement is also referred to as reflection arrangement. The testing signal 6 emitted by the terahertz wave transmission apparatus 5 is reflected at the external (air-sample, sample-air) and optionally at the internal (material irregularities) interfaces of the sample 3. The reflected-back signal 7 is recorded by the terahertz wave reception apparatus 1 and fed to the evaluation apparatus 10. Material irregularities can be identified on the basis of Fabry-Perot reflections, like in the case of the transmission arrangement. However, the reflection arrangement improves the accessibility to certain component geometries such as e.g. pipe connections.

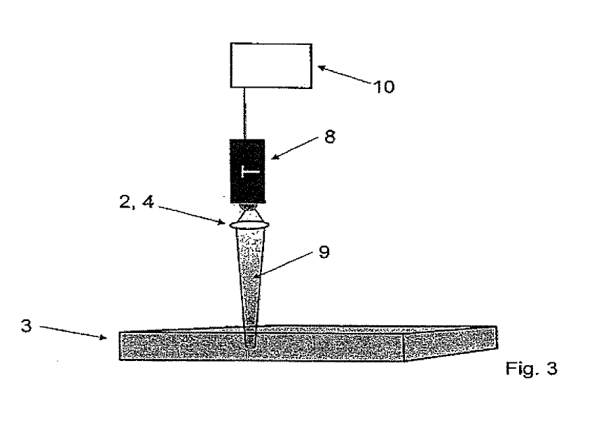

FIG. 3 shows a third embodiment of a terahertz spectroscopy analysis apparatus. Here, use is made of a combined transmission/reception apparatus 8, in which the terahertz wave transmission apparatus and the terahertz wave reception apparatus are provided in integrated form. Such an arrangement is also referred to as transceiver arrangement. The electromagnetic waves emitted as testing signal in this case follow the same path 9 as the waves reflected by the sample 3.

FIG. 4 shows an example of a signal, recorded by the terahertz wave reception apparatus 1, 8, after a first spectral transform. The spectral values H are plotted over frequency f. In addition to the first spectral transform, signal filtering can advantageously be carried out in order to filter out undesired interference signals. As is possible to identify in FIG. 4, no information in respect of material irregularities in the sample can be read from the illustrated signal profile. Hence a further spectral transform is carried out for an evaluable representation of the recorded waves.

FIG. 5 shows a result of a second spectral transform for forming the output function Q(x). For the purposes of the analysis, a sample without material irregularities was used. The sample consists of two plastics plates (polyethylene), each with a thickness of approximately 3.6 mm, which have been welded together. A clear signal peak can be identified at an optical depth value x of approximately 11 mm, which corresponds to the geometric thickness of the two plastics plates multiplied by the refractive index of typically 1.54 for polyethylene. This signal peak indicates the external interface of the sample (sample-air). Hence there are no material irregularities present in the sample.

FIG. 6 shows an output function Q(x) which was established using a sample that likewise consists of two plastics plates, respectively with a thickness of approximately 3.6 mm, which have been welded together. Here a delamination was deliberately created during the joining. Once again, it is possible to identify a signal peak at an optical depth value x of approximately 11 mm, which once again corresponds to the rear interface of the sample. A clear signal peak can additionally be identified at an optical depth value x of approximately 5.5 mm. This corresponds to the optical thickness of one of the plastics plates.

The signal peak at this point indicates a fault in the welding joint area; in this case, it is the delamination. The layer of air forming in this case between the plastics plates brings about additional echo pulses in the received terahertz signal as a result of a jump in the refractive index, and these additional echo pulses are reproduced in the output function Q(x) as a signal peak.

1. A method for material analysis of a sample (3) using terahertz spectroscopy for identifying material irregularities in the sample (3), comprising the following steps:
(a) a terahertz wave transmission apparatus (5, 8) is used to emit electromagnetic waves (6, 9) with a frequency in the terahertz range onto the sample (3) to be analyzed,
(b) a terahertz wave reception apparatus (1, 8) is used to record electromagnetic waves (7, 9) in the terahertz range from the sample (3),
(c) the recorded waves (7, 9) are fed to an evaluation apparatus (10) as a time-domain signal or as a frequency-domain signal by the terahertz wave reception apparatus (1, 8),
(d) to the extent that a signal fed to the evaluation apparatus (10) is a time-domain signal, the evaluation unit (10) converts the time-domain signal into a frequency-domain signal (H) using a first spectral transform,
(e) the evaluation apparatus (10) uses a second spectral transform to convert the frequency-domain signal (H) into an output function (Q(x)), by means of which corresponding optical depth values (x) are assigned to the established anomaly values (Q) of the sample,
(f) the evaluation apparatus (10) represents the output function (Q(x)) as anomaly values (Q) with respect to optical depth values (x) on an indicator unit and/or automatically determines at least one material irregularity (12) in the sample (3) from the output function (Q(x)) according to at least one predetermined comparison criterion.

2. The method as claimed in claim 1, characterized in that the sample (3) has at least two plastics parts, which are cohesively interconnected, and the output function (Q(x)) is evaluated in respect of at least one material irregularity (12) which indicates a defect in the cohesive connection.

3. The method as claimed in claim 2, characterized in that the plastics parts are interconnected by a plastics welding seam or area and/or by an adhesive seam or area and the output function (Q(x)) is evaluated in respect of at least one material irregularity (12) which indicates a defect in the plastics welding seam or area and/or in the adhesive seam or area.

4. The method as claimed in claim 1, characterized in that the sample (3) has at least one dielectric substance and the output function (Q(x)) is evaluated in respect of at least one material irregularity (12) in the dielectric substance.

5. The method as claimed in claim 1, characterized in that the sample (3) has at least one coating on a substrate, in particular a coating with paper, lacquer and/or ceramics, and the output function (Q(x)) is evaluated in respect of at least one material irregularity (12) which indicates a defect between the coating and the substrate.

6. The method as claimed in claim 1, characterized in that the output function (Q(x)) is evaluated in respect of the optical thickness of the sample and/or at least one layer of the sample.

7. The method as claimed in claim 1, characterized in that the evaluation apparatus (10) removes interferences from the frequency-domain signal (H) prior to the second spectral transform, using a reference frequency spectrum which was determined without a sample (3) in the beam path of the electromagnetic waves (6, 7, 9).

8. The method as claimed in claim 1, characterized in that the first and/or the second spectral transform is embodied as an integral transform.

9. The method as claimed in claim 1, characterized in that the first and/or the second spectral transform is embodied as a discrete spectral summation transform, in particular as a discrete Fourier transform (DFT) or as a fast Fourier transform (FFT).

10. The method as claimed in claim 1, characterized in that the utilized terahertz range comprises the range between 0.1 and 100 THz.

11. A terahertz spectroscopy analysis apparatus for analyzing the material of a sample (3) for identifying material irregularities in the sample, with a terahertz wave transmission apparatus (5, 8), a terahertz wave reception apparatus (1, 8) and an evaluation apparatus (10), wherein the terahertz wave transmission apparatus (5, 8) and the terahertz wave reception apparatus (1, 8) are respectively aligned with respect to the sample (3), and wherein the output signals of the terahertz wave reception apparatus (1, 8) are fed to the evaluation apparatus (10), wherein the evaluation apparatus (10) is prepared to carry out a method as claimed in one of the preceding claims.
